(19) United States
(12) Patent Application Publication
(10) Pub. No.: US 2010/0310790 A1
(43) Pub. Date: Dec. 9, 2010

(54) METHOD OF FORMING CARBON-CONTAINING LAYER

(75) Inventors: Shuo-Che Chang, Taichung County (TW); Shin-Yu Nieh, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NANYA TECHNOLOGY CORPORATION, Taoyuan (TW)

(21) Appl. No.: 12/480,693

(22) Filed: Jun. 9, 2009

(51) Int. Cl. B05D 3/00

(52) U.S. Cl. 427/570

(57) ABSTRACT

A method of forming a carbon-containing layer is provided. First, a substrate having a target layer thereon is provided. Next, a plasma containing CₓH_{y}F_{z} is generated. Thereafter, a plasma deposition process is performed to the substrate by using the plasma containing CₓH_{y}F_{z} so as to form the carbon-containing layer on the target layer.

### BACKGROUND OF THE INVENTION

1. Field of the Invention

The present invention relates to a semiconductor manufacturing process. More particularly, the present invention relates to a method of forming a carbon-containing layer.

2. Description of Related Art

The carbon-containing layer is one of the material layers generally used in semiconductor manufacturing processes. For example, the carbon-containing layer is used as a spacer, a hard mask layer and an etching stop layer, etc. Therefore, the characteristics of the carbon-containing layer effect the proceeding of the semiconductor manufacturing processes or the characteristics of the semiconductor devices formed by the semiconductor manufacturing processes. Generally, the process of forming the carbon-containing layer includes chemical vapor deposition (CVD) process, physical vapor deposition (PVD) process, and atomic layer deposition (ALD) process, etc. Among the processes, the chemical vapor deposition process and the atomic layer deposition process using for forming the carbon-containing layer respectively include performing a plasma enhanced chemical vapor deposition (PECVD) process and a plasma enhanced atomic layer deposition (PEALD) process by using plasma.

FIG. 1 is a schematic diagram of a carbon-containing layer formed by the conventional plasma deposition process. Referring to FIG. 1, the carbon-containing layer 106 is formed on a protruding structure 102 with a sidewall 104 by PECVD process using C₃H₆ as a reactive gas, for example. According to FIG. 1, the thickness of the carbon-containing layer 106 covering the sidewall 104 of the protruding structure 102 is uneven because the deposition rates on the sidewall 104 is different. Thus, the portion of the carbon-containing layer 106 covering the sidewall 104 and the portion of the carbon-containing layer 106 covering the substrate 100 form an acute angle 108.

Therefore, the carbon-containing layer cannot be formed conformally on the substrate by the above-mentioned processes, and the step coverage of the carbon-containing layer covering the protruding structure is poor. Accordingly, a non-conformal carbon-containing layer cannot be used as a spacer which requires to form conformally on a certain target. In addition, when the carbon-containing layer is used as a hard mask layer, the pealing of the carbon-containing layer resulted from the acute angle is easily observed during the rework process. In another word, the drawbacks of the carbon-containing layer such as non-conformal formation and poor step coverage limit the application of the carbon-containing layer, effect the proceeding of the semiconductor manufacturing processes using the carbon-containing layer and degrade the properties of the semiconductor devices including carbon-containing layer.

### SUMMARY OF THE INVENTION

The present invention is directed to a method of forming a carbon-containing layer, which the carbon-containing layer is conformally formed and has a good step coverage.

The present invention provides a method of forming a carbon-containing layer. First, a substrate having a target layer thereon is provided. Next, a plasma containing CₓH_{y}F_{z} is generated. Thereafter, a plasma deposition process is performed to the substrate by using the plasma containing CₓH_{y}F_{z} so as to form the carbon-containing layer on the target layer.

According to an embodiment of the present invention, x is from about 1 to 8, y is from about 1 to 10 and z is from about 1 to 10.

According to an embodiment of the present invention, the method of generating the plasma containing CₓH_{y}F_{z} includes using a fluorohydrocarbon gas as a reactive gas.

According to an embodiment of the present invention, the fluorohydrocarbon gas includes C₂HF₅, CHF₃, CH₂F₂, CH₃F, C₂H₂F₂, C₂H₄F₂, C₄HF₆, C₃H₂F₆, C₃H₂F₄, C₃HF₅, C₃H₆F₈, C₃HF₇ and their mixture.

According to an embodiment of the present invention, the method of generating the plasma containing CₓH_{y}F_{z} includes using a hydrocarbon gas and a fluorocarbon gas as reactive gases.

According to an embodiment of the present invention, the hydrocarbon gas includes alkane, alkene, alkyne, cycloalkane and alkadiene.

According to an embodiment of the present invention, the hydrocarbon gas comprises C₃H₆, CH₄, C₂H₂, C₄H₁₀, C₂H₆ and their mixture.

According to an embodiment of the present invention, the fluorocarbon gas includes CF₄, C₂F₈, C₂F₆, C₃F₈, C₄F₈, C₄H₁₀, C₄F₆, and their mixture.

According to an embodiment of the present embodiment, the target layer is a protruding structure and the carbon-containing layer is conformally formed on the target layer.

According to an embodiment of the present invention, the carbon-containing layer includes a fluorinated amorphous carbon.

According to an embodiment of the present invention, the plasma deposition process includes a plasma enhanced atomic layer deposition (PEALD) or a plasma enhanced chemical vapor deposition (PECVD) process.

In view of the above, the method of forming the carbon-containing layer according to the present invention uses the plasma containing CₓH_{y}F_{z} to deposit the carbon-containing layer. The carbon-containing layer formed by the above method has the characteristics of conformal formation and good step coverage such that the quality of the semiconductor manufacturing processes using the carbon-containing layer and the properties of the semiconductor devices including carbon-containing layer are improved and the carbon-containing layer is able to be generally used in the semiconductor manufacturing processes.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a carbon-containing layer formed by the conventional plasma deposition process.

FIG. 2 is a schematic flow chat of the method of forming a carbon-containing layer according to an embodiment of the present invention.

FIG. 3 is a schematic cross-sectional view of a carbon-containing layer according to a first embodiment of the present invention.

FIGS. 4A through 4B are schematic cross-sectional views showing the steps of a method of forming a carbon-containing layer according to a second embodiment of the present invention.

FIG. 5 is a schematic cross-sectional view of a carbon-containing layer according to a third embodiment of the present invention.

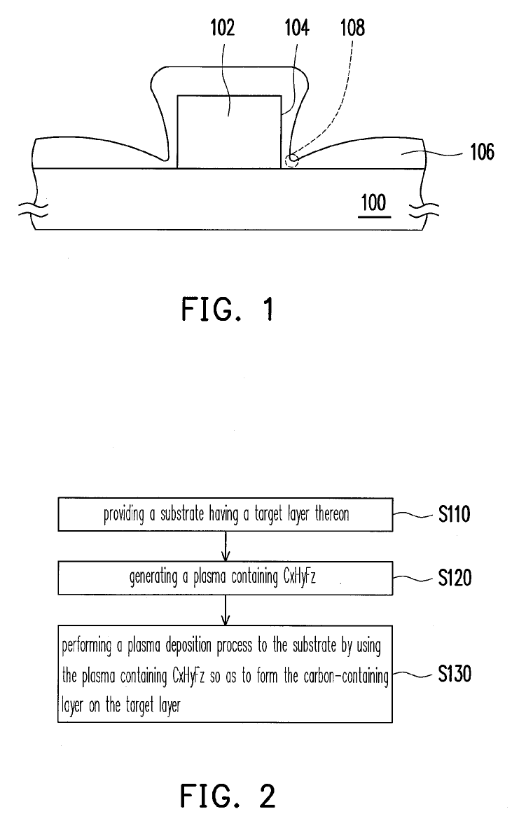

### DESCRIPTION OF EMBODIMENTS

### First Embodiment

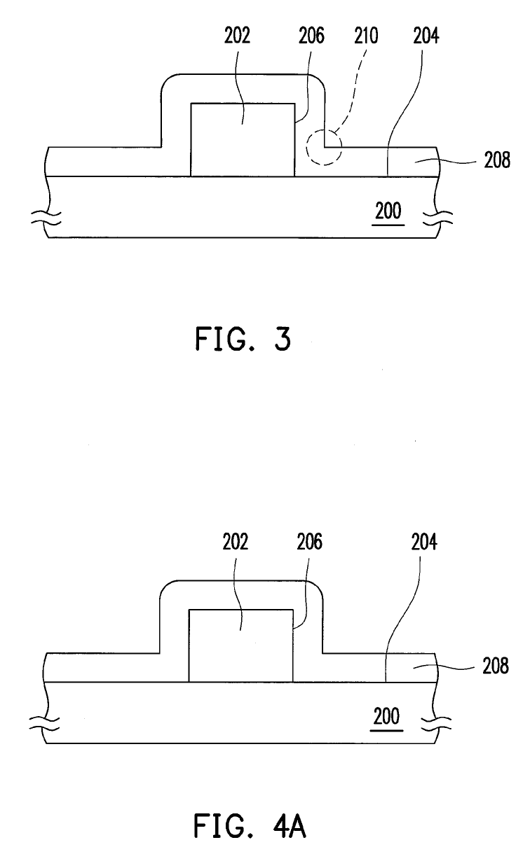

FIG. 2 is a schematic flow chat of the method of forming a carbon-containing layer according to an embodiment of the present invention. FIG. 3 is a schematic cross-sectional view of a carbon-containing layer according to a first embodiment of the present invention. In the present embodiment, the carbon-containing layer is used as a hard mask layer, for example.

As shown in FIGS. 2 and 3, first, a step S110 is performed. A substrate 200 is provided and a target layer 202 has been formed on the substrate 200. The substrate 200 is, for example, a silicon substrate. The target layer 202 is, for example, a protruding structure and has a sidewall 206 substantially perpendicular to the surface 204 of the substrate 200. A material of the target layer 202 may be a dielectric material or a conductive layer.

Next, referring to FIG. 2, the step S120 is performed. A plasma containing CₓH_{y}F_{z} is generated, wherein x is from about 1 to 8, y is from about 1 to 10 and z is from about 1 to 10. In the present embodiment, the method of generating the plasma containing CₓH_{y}F_{z} includes using a fluorohydrocarbon gas as a reactive gas. The fluorohydrocarbon gas includes C₂HF₅, CHF₃, CH₂F₂, CH₃F, C₂H₂F₂, C₂H₄F₂, C₄HF₆, C₃H₂F₆, C₃H₂F₄, C₃HF₅, C₃H₆F₈, C₃HF₇ and their mixture. In another embodiment, the method of generating the plasma containing CₓH_{y}F_{z} includes using a hydrocarbon gas and a fluorocarbon gas as reactive gases, for example. The hydrocarbon gas includes alkane, alkene, alkyne, cycloalkane and alkadiene such as C₃H₆, CH₄, C₂H₂, C₄H₁₀, C₂H₆ and their mixture and the fluorocarbon gas includes CF₄, C₂F₈, C₂F₆, C₃H₈, C₄F₈, C₄F₁₀, C₄F₆, and their mixture. In an embodiment, the process parameters for generating the plasma is described in the following. The flowing rate of the hydrocarbon gas is from 50 sccm (standard cubic centimeters per minute) to 3,000 sccm and the flowing rate of the fluorocarbon gas is from 200 sccm to 5,000 sccm. In addition, the pressure is, for example, from 2 torr to 10 torr, the temperature may be 0° C. to 550° C. and the power may be from 200 W to 2,000 W. In the step S120, He, Ar or a combination thereof can also be used. Particularly, in the present invention, the values of x, y and z of the plasma containing CₓH_{y}F_{z} is not limited, and thus a variety of combinations of gases including carbon, hydrogen and fluorine can be used for forming the plasma, and the process margin of the method of forming the carbon-containing layer is significantly improved.

Thereafter, referring to FIG. 2 and FIG. 3, the step S130 is implemented. A plasma deposition process is performed to the substrate 200 by using the plasma containing CₓH_{y}F_{z} so as to form the carbon-containing layer 208 on the target layer 202. The plasma deposition process may be a PEALD process, a PECVD process or other plasma deposition processes. In the present embodiment, the carbon-containing layer 208 is conformally formed on the target layer 202, and a material of the carbon-containing layer 208 is, for example, fluorinated amorphous carbon.

According to FIG. 3, the carbon-containing layer 208 is conformally formed on the target layer 202 such that the thickness of the carbon-containing layer 208 on the sidewall 206 of the target layer 202 is substantially the same. Besides, the portion of the carbon-containing layer 208 on the sidewall 206 of the target layer 202 and the portion of the carbon-containing layer 208 on the substrate 200 form a rounding corner 210, which is about 85°. In another word, the carbon-containing layer formed by the above method has the characteristics of conformal formation and good step coverage, such that the adhesion between the carbon-containing layer and the target layer is improved and the structure of the carbon-containing layer is rigid. Therefore, during the rework process, the hard mask layer formed by the carbon-containing layer is not peeled off and thus the quality of the rework process is improved. Certainly, the hard mask layer can be used in other processes and the rework process mentioned herein is an example of the processes using a hard mask layer.

In the present embodiment, the carbon-containing layer is used as a hard mask layer, but the present invention is not limited thereto. That is to say, the carbon-containing layer formed by the above method can be applied to other processes or used as other semiconductor structures. Some examples are numerated in the following for illustration purposes.

### Second Embodiment

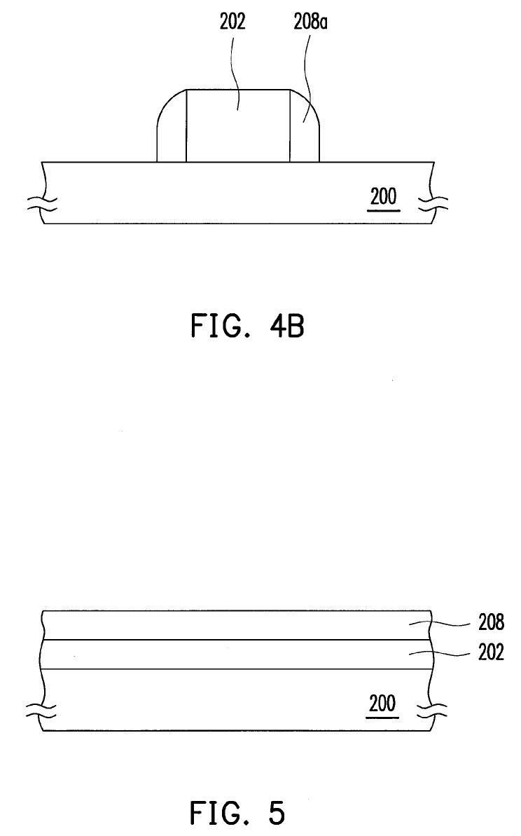

FIGS. 4A through 4B are schematic cross-sectional views showing the steps of a method of forming a carbon-containing layer according to a second embodiment of the present invention.

As shown in FIG. 2 and FIG. 4A, first, a step S110 is performed. A substrate 200 is provided and a target layer 202 has been formed on the substrate 200. The substrate 200 is, for example, a silicon substrate. The target layer 202 is, for example, a gate structure and includes a sidewall 206 substantially perpendicular to the surface 204 of the substrate 200.

Next, referring to FIG. 2, the step S120 is performed. A plasma containing CₓH_{y}F_{z} is generated. The process parameters of the method for generating the plasma containing CₓH_{y}F_{z} are referred to the description of the first embodiment, and are not iterated herein.

Thereafter, referring to FIG. 2 and FIG. 4A, the step S130 is implemented. A plasma deposition process is performed to the substrate 200 by using the plasma containing CₓH_{y}F_{z} so as to form the carbon-containing layer 208 on the target layer 202. In the present embodiment, the carbon-containing layer 208 is conformally formed on the target layer 208. The forming method and material of the carbon-containing layer 208 are referred to the description of the first embodiment, and are not iterated herein.

Referring to FIG. 4B, the method of forming the carbon-containing layer 208 further includes removing a portion of the carbon-containing layer 208 so as to form a carbon-containing layer 208a used as a spacer in the present embodiment. The method of removing a portion of the carbon-containing layer 208 is, for example, by performing a dry etching.

According to FIGS. 4A and 4B, the carbon-containing layer 208 is conformally formed on the target layer 202 such that the thickness of the carbon-containing layer 208 on the sidewall 206 of the target layer 202 is substantially the same and the carbon-containing layer 208a is desirably attached on the sidewall 206 of the target layer 202. In another word, the carbon-containing layer 208a formed by the above method has the characteristics of conformal formation and good step coverage, such that the adhesion between the carbon-containing layer and the target layer is improved and the structure of the carbon-containing layer is rigid. It is noted that the carbon-containing layer is used as a spacer on the sidewall of the gate structure in the present embodiment, but the present invention is not limited thereto. In another word, the carbon-containing layer 208a can be used as a spacer of other structures. Besides, the spacer formed by the carbon-containing layer 208a can be retained or removed in the following processes.

In the above embodiments, the carbon-containing layer is formed on a target layer having protruding structures as examples, but the present invention is not limited thereto. Other applications and the characteristics of the carbon-containing layer are described as follows.

### Third Embodiment

FIG. 5 is a schematic cross-sectional view of a carbon-containing layer according to a third embodiment of the present invention.

As shown in FIG. 2 and FIG. 5, first, a step S110 is performed. A substrate 200 is provided and a target layer 202 has been formed on the substrate 200. The substrate 200 is, for example, a silicon substrate. The target layer 202 may be a dielectric material layer or a conductive material layer with a flat surface.

Next, referring to FIG. 2, the step S120 is performed. A plasma containing CₓH_{y}F_{z} is generated. The process parameters of the method for generating the plasma containing CₓH_{y}F_{z} are referred to the descriptions of the first embodiment, and are not iterated herein.

Thereafter, referring to FIG. 2 and FIG. 5, the step S130 is implemented. A plasma deposition process is performed to the substrate 200 by using the plasma containing CₓH_{y}F_{z} so as to form the carbon-containing layer 208 on the target layer 202. In the step S130, the carbon-containing layer 208 is conformally formed on the target layer 202. The forming method and material of the carbon-containing layer 208 are referred to the descriptions of the first embodiment, and are not iterated herein.

In the present embodiment, the target layer 202 can be an oxide layer, a polysilicon layer, a SiOC layer, a nitride layer, a copper layer or a gate structure, and thus the carbon-containing layer 208 is used as a barrier layer, an etching stop layer, a low dielectric material layer or other suitable films or layers. The carbon-containing layer 208 formed by the above method has the characteristics of conformal formation and good step coverage, such that the adhension between the carbon-containing layer 208 and the target layer 202 is improved. Accordingly, the spacer layer, the etching stop layer, the low dielectric material layer or other suitable films or layers formed by the carbon-containing layer have good barrier, isolation and dielectric properties, such that the quality of the semiconductor manufacturing processes using the carbon-containing layer and the characteristics of the semiconductor devices including the carbon-containing layer are improved and the carbon-containing layer is able to be generally used in semiconductor manufacturing processes.

In view of the above, the method of forming the carbon-containing layer according to the present invention uses the plasma containing CₓH_{y}F_{z} to deposit the carbon-containing layer. The carbon-containing layer deposited by the plasma containing CₓH_{y}F_{z} has the characteristics of conformal formation and good step coverage. Accordingly, the carbon-containing layer have good barrier, isolation and dielectric properties, such that the quality of the semiconductor manufacturing processes using the carbon-containing layer and the characteristics of the semiconductor devices including the carbon-containing layer are improved, and the carbon-containing layer is able to be generally used in semiconductor manufacturing processes.

Particularly, in the present invention, the values of x, y and z of the plasma containing CₓH_{y}F_{z} is not limited, and thus a variety of combinations of gases including carbon, hydrogen and fluorine can be used for forming the plasma, and the process margin of the method of forming the carbon-containing layer is significantly improved. In addition, the method of forming the carbon-containing layer according to the present invention is performed using existing equipment and gases, and therefore the cost of the semiconductor manufacturing process is not increased.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method of forming a carbon-containing layer, comprising:
providing a substrate having a target layer thereon;
generating a plasma containing CₓH_{y}F_{z}; and
performing a plasma deposition process to the substrate by using the plasma containing CₓH_{y}F_{z} so as to form the carbon-containing layer on the target layer.

2. The method of claim 1, wherein x is from about 1 to 8, y is from about 1 to 10 and z is from about 1 to 10.

3. The method of claim 1, wherein the method of generating the plasma containing CₓH_{y}F_{z} comprises using a fluorohydrocarbon gas as a reactive gas.

4. The method of claim 3, wherein the fluorohydrocarbon gas comprises C₂HF₅, CHF₃, CH₂F₂, CH₃F, C₂H₂F₂, C₂H₄F₂, C₄HF₆, C₃H₂F₆, C₃H₂F₄, C₃HF₅, C₃H₆F₈, C₃HF₇ and their mixture.

5. The method of claim 1, wherein the method of generating the plasma containing CₓH_{y}F_{z} comprises using a hydrocarbon gas and a fluorocarbon gas as reactive gases.

6. The method of claim 5, wherein the hydrocarbon gas comprises alkane, alkene, alkyne, cycloalkane and alkadiene.

7. The method of claim 6, wherein the hydrocarbon gas comprises C₃H₆, CH₄, C₂H₂, C₄H₁₀, C₂H₆ and their mixture.

8. The method of claim 5, wherein the fluorocarbon gas comprises CF₄, C₂F₈, C₂F₆, C₃F₈, C₄F₈, C₄F₁₀, C₄F₆, and their mixture.

9. The method of claim 1, wherein the target layer is a protruding structure and the carbon-containing layer is conformally formed on the target layer.

10. The method of claim 1, wherein the carbon-containing layer comprises a fluorinated amorphous carbon.

11. The method of claim 1, wherein the plasma deposition process comprises a plasma enhanced atomic layer deposition (PEALD) process or a plasma enhanced chemical vapor deposition (PECVD) process.
